(19) United States
(12) Patent Application Publication
(10) Pub. No.: US 2007/0236422 A1
(43) Pub. Date: Oct. 11, 2007

(54) Display device and driving method of the same

(75) Inventors: Kyong-Tae Park, Uijeonbu-si (KR); Chun-Seok Ko, Hwaseong-si (KR); Si-Duk Sung, Seoul (KR); Jung-Nam Park, Hamyang-gun (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/655,876

(22) Filed: Jan. 18, 2007

(30) Foreign Application Priority Data
Apr. 10, 2006 (KR) 10-2006-0032272

(51) Int. Cl. G09G 3/30

(52) U.S. Cl. 345/76

(57) ABSTRACT

A display device includes a first pixel representing a first color, a second pixel representing a second color, a first scanning line connected to the first pixel and transmitting a first scanning signal, a second scanning line connected to the second pixel and transmitting a second scanning signal, a data line connected to the first pixel and the second pixel and transmitting a data voltage, a scanning driver for applying the scanning signal to the scanning line, a gray voltage generator for generating gray voltage sets respective to the different colors of pixels, and a data driver for converting an image signal for the first pixel into a gray voltage selected from the set of gray voltages for the first pixel et and converting a second image signal into a second gray voltage selected from the set of gray voltages for the second pixel and sequentially applying the selected gray voltages to the data line serving the two pixels.

### CROSS-REFERENCE TO RELATED APPLICATION

This application claims priority to and the benefit of Korean Patent Application No. 10-2006-0032272 filed in the Korean Intellectual Property Office on Apr. 10, 2006, the contents of which are incorporated herein by reference.

### FIELD OF THE INVENTION

The present invention relates to a display device.

### DESCRIPTION OF THE RELATED ART

Recently, flat panel displays that may be substituted for cathode ray tubes (CRT) have been studied vigorously, and an organic light emitting diode (OLED) display has been particularly spotlighted as a next-generation flat panel display because of its excellent luminance and viewing angle characteristics.

Generally, an active matrix flat panel display includes a plurality of pixels arranged in a matrix that displays images by controlling the luminance of the pixels based on given luminance information. An OLED display is a self-emissive display device that displays images by electrically exciting a light emitting organic material. The OLED display has low power consumption and fast pixel response time, thereby being suitable for displaying moving images.

A pixel of an OLED display includes an OLED and a driving thin film transistor (TFT). The TFTs are divided into poly-silicon TFTs and amorphous silicon TFTs according to the type of the active layer of the TFT. An OLED display employing poly-silicon TFTs is being widely used since it has many advantages, but the manufacturing process of the TFTs is complicated and costly and it is difficult to make a large screen OLED display.

On the other hand, it is easy to fabricate a large screen OLED display employing amorphous silicon TFTs and the manufacturing process has fewer steps than an OLED display employing poly-silicon TFTs.

An OLED display includes a plurality of pixels forming one dot. Organic emission layers of the respective pixels emit light having different colors from each other such that a color of one dot is determined by synthesizing light having different colors. However, the light emitting efficiency and life-time of the organic emission layers corresponding to different colors are different.

### SUMMARY OF THE INVENTION

An exemplary embodiment of the present invention provides a display device where the scanning lines and data lines are associated with the different colors of pixels so that each color of pixel is provided with a respective set of gray voltages. For example, when a first pixel represents a first color and a second pixel represents a second color, a data line sequentially applies the sets of data voltages to the individually scanned pixels.

Another embodiment of the present invention provides a display device, which includes a plurality of pixels representing one of a plurality of colors, respectively, a plurality of scanning lines connected to the pixels and transmitting scanning signals, a plurality of data lines connected to the pixels and transmitting data voltages, a scanning driver for applying the scanning signals to the scanning lines, a gray voltage generator for generating a plurality of gray voltage sets in accordance with the colors, and a data driver for selecting gray voltages corresponding to image signals from gray voltages included in the gray voltage set, and selecting portions of the selected gray voltages to output to the data lines as the data voltages, wherein the data lines are connected to the pixels representing colors that are different from each other, respectively.

The data driver includes a first converter for converting an image signal corresponding to a pixel having a first color into the data voltage, a second converter converting an image signal corresponding to a pixel having a second color into the data voltage, and a selector for selecting one of the data voltages from the first converter and the second converter.

The first converter may be supplied with a gray voltage set with respect to the first color, and the second converter may be supplied with a gray voltage set with respect to the second color.

The data driver may alternately convert the image signals with respect to the first color and the second color into the data voltages.

The gray voltage generator may supply gray voltage sets with respect to corresponding colors based on the image signals to the converter.

Yet another embodiment of the present invention provides a driving method of a display device including a first pixel and a second pixel that are connected to different scanning lines and to the same data line, respectively, which including generating a first gray voltage set for the first pixel and a second gray voltage set for the second pixel, converting a first image signal for the first pixel into a first gray voltage of gray voltages included in the first gray voltage set, applying the first gray voltage to the data line, converting a second signal for the second pixel into a second gray voltage of gray voltages included in the second gray voltage set, and applying the second gray voltage to the data line.

The conversion of the first image signal and the conversion of the second image signal may be simultaneously performed, and the driving method may further include selecting the first gray voltage of the first gray voltage and the second gray voltage before application of the first gray voltage, and selecting the second gray voltage of the first gray voltage and the second gray voltage before application of the second gray voltage.

The driving method may further include substantially simultaneously converting the first image signal into the first gray voltage and into a third gray voltage of gray voltages included in the second gray voltage set, selecting the first gray voltage of the first gray voltage and the third gray voltage, substantially simultaneously converting the second image signal into the second gray voltage and into a fourth gray voltage of gray voltages included in the first gray voltage set, and selecting the second gray voltage of the second gray voltage and the fourth gray voltage. The driving method may further include selectively outputting the first gray voltage set and the second gray voltage set.

### BRIEF DESCRIPTION OF THE DRAWINGS

The forgoing and other features and advantages of the present invention will become more apparent from a reading of the ensuing description when read together with the drawing, in which:

FIG. 1 is a block diagram of an OLED display according to an exemplary embodiment of the present invention;

FIG. 2 is an equivalent circuit diagram of a pixel of an OLED display according to an exemplary embodiment of the present invention;

FIG. 3 shows pixel arrangements of an OLED display according to an exemplary embodiment of the present invention.

FIG. 4 is a block diagram of a data driver according to an exemplary embodiment of the present invention;

FIG. 5 is a block diagram of the digital-analog converter shown in FIG. 4;

FIG. 6 is a block diagram of a digital-analog converter according to an exemplary another embodiment of the present invention;

FIG. 7 is a block diagram of a gray voltage generator of an OLED display according to another exemplary embodiment of the present invention; and

FIG. 8 shows signal waveforms for operating an OLED display according to embodiments of the present invention.

### DETAILED DESCRIPTION OF THE EMBODIMENTS

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

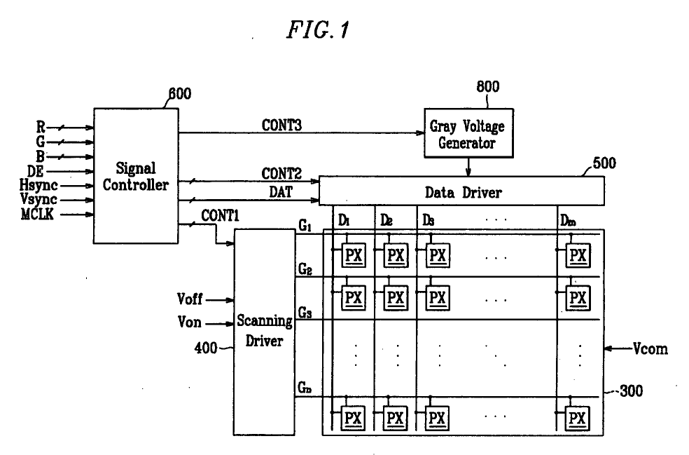

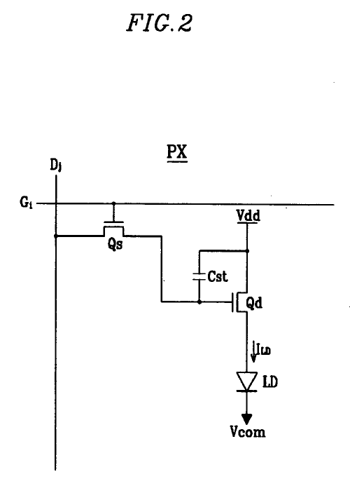

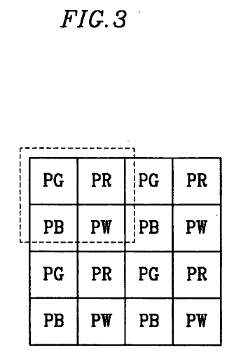

FIG. 1 is a block diagram of an OLED display according to an exemplary embodiment of the present invention, FIG. 2 is an equivalent circuit diagram of a pixel of an OLED display according to an exemplary embodiment of the present invention, and FIG. 3 shows pixel arrangements of an OLED display according to an exemplary embodiment of the present invention.

Referring to FIG.1, an OLED display according to an exemplary embodiment includes a display panel 300, a scanning driver 400 and a data driver 500 that are connected to the display panel 300, a gray voltage generator 800 coupled to the data driver 500, and a signal controller 600 that controls the above elements.

The display panel 300 includes a plurality of signal lines G₁-Gₙ and D₁-Dₘ, a plurality of voltage lines (not shown), and a plurality of pixels PX connected to the signal lines G₁-Gₙ and D₁-Dₘ and the voltage lines and arranged substantially in a matrix, in a circuital view shown in FIG. 2.

The signal lines G₁-Gₙ and D₁-Dₘ include a plurality of scanning lines G₁-Gₙ for transmitting scanning signals and a plurality of data lines D₁-Dₘ for transmitting data signals. The scanning lines G₁-Gₙ extend substantially in a row direction and substantially parallel to each other, while the data lines D₁-Dₘ extend substantially in a column direction and substantially parallel to each other. Each the voltage lines transmits a driving voltage Vdd, etc.

Referring to FIG. 2, each pixel PX, for example, a pixel PX in an i-th row (i=1, 2, . . . , n) and a j-th column (j=1, 2, . . . , m), is connected to scanning line Gᵢ and a data line Dⱼ and includes an OLED LD, a driving transistor Qd, a capacitor Cst, and a switching transistor Qs.

Switching transistor Qs, illustratively a TFT, has three terminals a control terminal connected to a scanning line Gᵢ, an input terminal connected to a data line Dⱼ, and an output terminal connected to a driving transistor Qd. Switching transistor Qs transmits a data voltage in response to a scanning signal applied to the scanning line Gᵢ.

Driving transistor Qd, illustrativly, a TFT also has three terminals such as a control terminal connected to the output terminal of switching transistor Qs, an input terminal connected to a driving voltage Vdd, and output terminal connected to the OLED LD. Driving transistor Qd flows an output current I_{LD} having a magnitude defined based on a voltage across the control terminal and the output terminal.

The capacitor Cst is connected between the control terminal and the input terminal of driving transistor Qd. The capacitor Cst stores and maintains the data voltage applied to the control terminal of driving transistor Qd through switching transistor Qs.

The OLED LD has an anode connected to the output terminal of driving transistor Qd and a cathode connected to a common voltage Vcom. The OLED LD emits light having an intensity depending on the output current I_{LD} of driving transistor Qd.

The OLED LD uniquely represents one of primary colors or white color. An example of a set of the primary colors includes red, green, and blue, and a spatial sum of the primary colors is recognized as a desired color. The white color is for improving the luminance. Hereinafter, pixels representing red, green, blue, and white, are respectively referred to as red pixels PR, green pixels PG, blue pixels PB, and white pixels PW.

Referring to FIG. 3, in an OLED display according to an exemplary embodiment of the present invention, four pixels PX representing four colors, for example, red, green, blue, and white, respectively, and arranged in a 2'2 matrix form one dot, and the dots are repeatedly disposed in a row direction and in column direction. In each dot, the red pixel PR is opposite to the blue pixel PB in a diagonal direction, and the green pixel PG is opposite to the white pixel PW in the diagonal direction. In one dot, it is the most preferable to have a structure in which a green pixel PG and a white pixel PW face each other in the diagonal direction with respect to a color characteristic of the OLED.

Switching transistor Qs and driving transistor Qd are n-channel field effect transistors (FETs) including amorphous silicon or polysilicon. However, at least one of the transistors Qs and Qd may be a p-channel FET operating in a manner opposite to n-channel FETs. In addition, the connections of the transistors Qs and Qd, the capacitor Cst, and the OLED LD may be varied.

Referring to FIG.1 again, the scanning driver 400 is connected to the scanning lines G₁-Gₙ of the display panel 300, and synthesizes a high voltage Von for turning on the switching transistors Qs and a low voltage Voff for turning off the switching transistors Qs to generate scanning signals for application to the scanning lines G₁-Gₙ.

The data driver 500 is connected to the data lines D₁-Dₘ of the display panel 300 and applies data voltages to the data lines D₁-Dₘ.

The gray voltage generator 800 generates different sets of gray voltages for each color to output them the data driver 500. The gray voltages with respect to each color are determined considering emitting efficiency and life-time of an emitting material of each color.

The signal controller 600 controls the scanning driver 400, the data driver 500, and the gray voltage generator 800, etc.

The operation of the signal controller 600 will be briefly described.

The signal controller 600 is supplied with input image signals R, G, and B of three colors and input control signals for controlling the display thereof from an external graphics controller (not shown). The input image signals R, G, and B contain luminance information of each pixel PX, and the luminance has a predetermined number of, for example 1024(=2¹⁰), 256(=2⁸) or 64(=2⁶) grays. The input control signals include a vertical synchronization signal Vsync, a horizontal synchronization signal Hsync, a main clock signal MCLK, a data enable signal DE, etc.

After extracting an image signal for a white color of the three color image signals R, G, and B and modifying the image signals R, G, and B, the signal controller 600 processes the image signals R, G, and B to be suitable for the operation of the display panel 300 to generate output image signals DAT of four colors, for example, red, green, blue, and white, and to arrange them to be suitable for the pixel arrangement shown in FIG. 3.

The signal controller 600 may include a frame memory (not shown) or a lookup table (not shown) for generation of the output image signals DAT.

The signal controller 600 also generates scanning control signals CONT1, data control signals CONT2, and gray control signals CONT3, and transmits the scanning control signals CONT1 to the scanning driver 400, the data control signal CONT2 and the processed output image signals DAT to the data driver 500, and the gray control signals CONT3 to the gray voltage generator 800.

The scanning control signals CONT1 include a scanning start signal STV for instructing to start scanning, and at least one clock signal for controlling the output time of the high voltage Von. The scanning control signals CONT1 may further include an output enable signal OE for defining the duration of the high voltage Von.

The data control signals CONT2 include a horizontal synchronization start signal STH for informing of start of data transmission for a group of pixels PX, a load signal LOAD for instructing to apply the data voltages to the data lines D₁-Dₘ, and a data clock signal HCLK.

Each of the units 400, 500, 600, and 800 may include at least one integrated circuit (IC) chip mounted on the LC panel assembly 300 or on a flexible printed circuit (FPC) film as a tape carrier package (TCP) type, which are attached to the panel assembly 300. Alternately, at least one of the units 400, 500, 600, 700, and 800 may be integrated with the display panel 300 along with the signal lines G₁-Gₙ, D₁-Dₘ and the transistors Qs and Qd. As a further alternative, all the units 400, 500, 600, and 800 may be integrated into a single IC chip, but at least one of the units 400, 500, 600, and 800 or at least one circuit element of at least one of the units 400, 500, 600, and 800 may be disposed outside of the single IC chip.

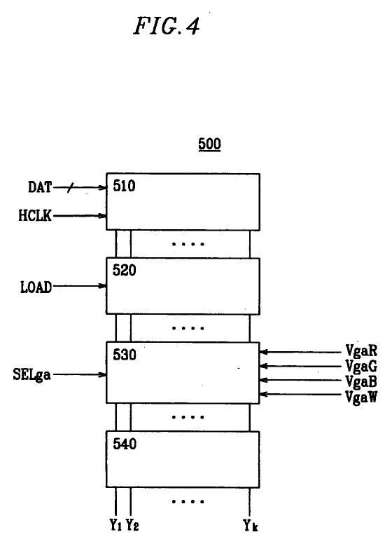

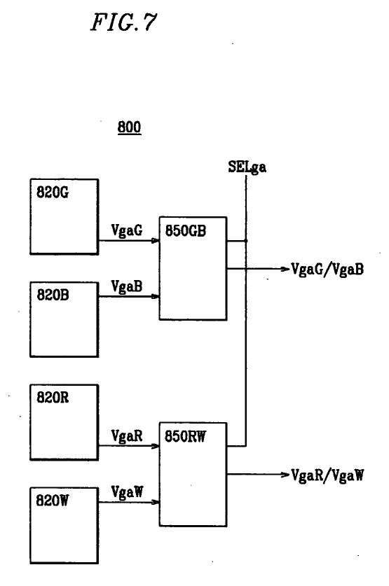

Now, the data driver according to an exemplary embodiment of the present invention will be described with reference to FIGS. 4 and 7.

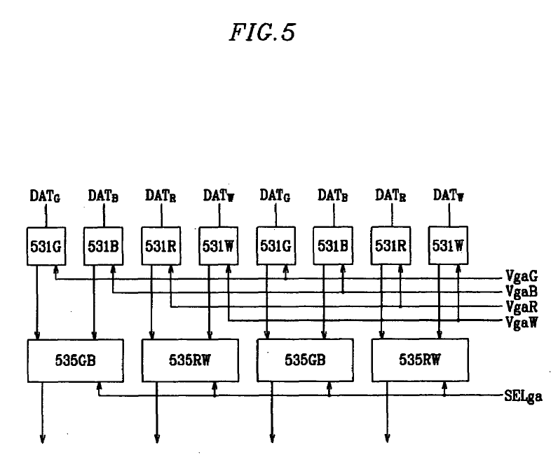

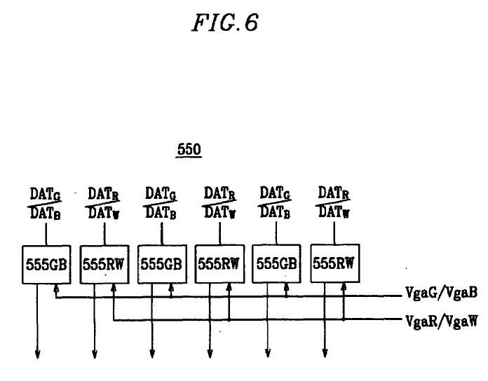

FIG. 4 is a block diagram of a data driver according to an exemplary embodiment of the present invention, FIG. 5 is a block diagram of the digital-analog converter shown in FIG. 4, and FIG. 6 is a block diagram of a digital-analog converter according to an exemplary another embodiment of the present invention. In addition, FIG. 7 is a block diagram of a gray voltage generator of an OLED display according to another exemplary embodiment of the present invention.

The data driver 500 includes at least one data driving IC (integrated circuit) connected to the data lines D₁-Dₘ.

Referring to FIG. 4, the data driving IC includes a shift register 510, a latch 520, a digital-analog converter 530, and an output buffer 540 that are connected sequentially.

The shift register 510 is supplied with a horizontal synchronization start signal STH (or a shift clock signal), and then transmits image signals DAT to the latch 520 in accordance with a data clock signal HCLK. The data driver 500 may include a plurality of data driving ICs, and in this case, a shift resistor 510 of one data driving IC transmits a shift clock signal to a shift resistor of the next data driving IC.

The latch 520 stores output image signals DAT and outputs the stored output image data DAT, to the digital-analog converter 530 in response to the load signal LOAD.

The digital-analog converter 530 is supplied with sets of gray voltages that are different for each color, that is, four sets of gray voltages VgaR, VgaG, VgaB, and VgaW with respect to red, green, blue, and white colors, respectively, and selects gray voltages from the gray voltage set VgaR, VgaG, VgaB, and VgaW corresponding to the output image signal DAT to output them to the output buffer 540.

The output buffer 540 outputs the output voltages from the digital-analog converter 530 to output terminals Y₁-Yₖ) connected to the data lines D₁-Dₘ as data voltages and maintains the state for one horizontal period (1H).

In an example shown in FIG. 5, the digital-analog converter 530 includes a plurality of converters 531G, 531B, 531R, and 531W, and a plurality of selectors 535GB and 535RW.

The two adjacent converters 531G and 531B, and 531R and 531W, are connected to one selector 535GB and 535RW in a pair, respectively.

The four adjacent converters 531R, 531G, 531B, and 531W are supplied with the output image signals DAT_{R}, DAT_{G}, DAT_{B}, and DAT_{W} with respect to the different colors, for example, red, green, blue, and white, and are supplied with the gray voltage sets VgaR, VgaG, VgaB, and VgaW corresponding to the four colors, respectively. Hereinafter, a converter 531G supplied with the gray voltage set VgaR with respect to the green color is referred to as a green converter, a converter 531B supplied with the gray voltage set VgaB with respect to the blue color is referred to as a blue converter, a converter 531R supplied with the red voltage set VgaR with respect to the red color is referred to as a red converter, and a converter 531W supplied with the white voltage set VgaR with respect to the white color is referred to as a white converter.

Thereby, the red, green, blue, and white converters 531R, 531G, 531B, and 531W are supplied with the corresponding image signals DAT_{R}, DAT_{G}, DAT_{B}, and DAT_{W} to select and output gray voltages from the gray voltage sets VgaR, VgaG, VgaB, and VgaW based on the output image signals DAT_{R}, DAT_{G}, DAT_{B}, and DAT_{W}, respectively.

The selectors 535GB and 535RW respectively select and output one of two output voltages from the two connected converters 531 to the output buffer 540 in response to a selection signal SELga. The selectors 535GB and 535RW may be multiplexers.

The digital-analog converter 550 shown in FIG. 6 includes a plurality of converters 555GB and 555RW.

Each converter 555GB and 555RW is alternately supplied with image signals DAT_{R} and DAT_{G}, or DAT_{B} and DAT_{W}, with respect to two colors from the latch 520, and is also alternately supplied with gray voltage sets VgaR and VgaG, or VgaB and VgaW, corresponding to two colors from the gray voltage generator 800.

At this time, the output image signals DAT_{R}, DAT_{G}, DAT_{B}, DAT_{W} and the gray voltage sets VgaR, VgaG, VgaB, and VgaW applied to the adjacent converters 555GB and 555RW are the output image signals and the gray voltage sets with respect to different colors.

For example, the odd converters 555GB are alternately supplied with the green and blue image signals DAT_{G} and DAT_{B} and the green and blue gray voltage sets VgaG and VgaB from the gray voltage generator 800. The even-th converters 555RW are alternately supplied with the red and white image signals DAT_{R} and DAT_{W} and the red and white gray voltage sets VgaR and VgaW from the gray voltage generator 800.

As above-described, an example of the gray voltage generator 800 for outputting the four gray voltage sets according to the conditions is shown in FIG. 7. A gray voltage generator 800 shown in FIG. 7 includes a plurality of voltage generators 820R, 820G, 820B, and 820W and a plurality of output units 850GB and 850RW.

Each voltage generator 820R, 820G, 820B, and 820W generates one of the green, blue, red, and white gray voltage sets VgaG, VgaB, VgaR, and VgaW. Each voltage generator 820R, 820G, 820B, and 820W may include at least one resistor string for dividing a predetermined voltage to generate a plurality of gray voltages. At this time, the predetermined voltage that is divided may be different in accordance with the assigned color, and, as above-described, may be determined considering the emitting efficiency and the life-time of an emitting material of each color.

The number of voltage generators 820R, 820G, 820B, and 820W is four, and the number of output units 850GB and 850RW is two. Two adjacent voltage generators 820G and 820B, and 820R and 820W, are connected to one output unit 850GB and 850RW, respectively.

Each output unit 850 is supplied with the two gray voltage sets VgaG and VgaB, or VgaR and VgaW, with respect to two colors from two voltage generators 820R, 820G, 820B, and 820W, and selects one of gray voltage sets VgaG, VgaB, VgaR, and VgaW based on a selection signal SELga to output the selected gray voltage set.

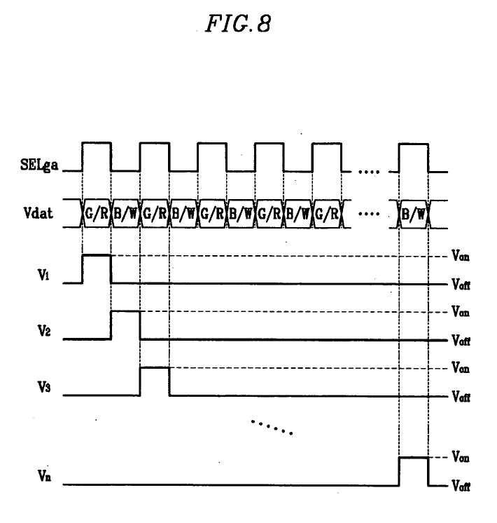

Next, referring to FIG. 8, operations of the OLED display shown in FIGS. 1 to 5 will be described.

FIG. 8 shows signal waveforms for operating an OLED display according to embodiments of the present invention.

The signal controller 600 outputs output image signals DAT for red, green, blue, and white colors, scanning control signals CONT1, data control signals CONT2, and gray control signals CONT3 (or a selection signal SELga).

In response to the data control signals CONT2 from the signal controller 600, the data driver 500 receives the four color analog output image signals DAT_{R}, DAT_{G}, DAT_{B}, and DAT_{W} corresponding to two pixel rows.

The latch 520 outputs the green output image signal DATG to the green converter 531G, the blue output image signal DATB to the blue converter 531B, the red output image signal DAT_{R} to the red converter 531R, and the output image signal DAT_{W} to the white converter 531W In accordance with a load signal LOAD, respectively.

Each converter 531R, 531G, 531B, and 531W selects analog gray voltages from the corresponding gray voltage sets VgaR, VgaG, VgaB, and VgaW based on the image signals DAT_{R}, DAT_{G}, DAT_{B}, and DAT_{W} to convert the analog image signals DAT_{R}, DAT_{G}, DAT_{B}, and DAT_{W} into digital output image signals DAT_{R}, DAT_{G}, DAT_{B}, and DAT_{W}.

When the selection signal SELga has a high level, the selectors 535GB and 535RW each selects and outputs one of the output voltages of the green converter 531 G and the red converter 53 1R, respectively. On the contrary, when the selection signal SELga has a low level, the selectors 535GB and 535RW each selects and outputs one of output voltages of the blue converter 531B and the white converter 531W, respectively.

The output buffer 540 outputs the output voltages from the green converter 531G and the red converter 531R, or the output voltages from the blue converter 531G and the white converter 531R as data voltages Vdat to the respective data lines D₁-Dₘ.

The scanning driver 400, in response to the scanning control signal CONT1 from the signal controller 600, changes states of scanning signals Vg₁-Vgₙ sequentially applied to the scanning signal lines G₁-Gₙ into a high voltage Von.

Thereby, the switching elements Qs of pixel rows including the green pixels PG and the red pixels PR, or pixel rows including the blue pixels PB and white Pixels PW, are turned on. By the turning on of the switching elements Qs, the driving transistors Qd of each pixel PG and PR, or PB and PW, are supplied with the data voltages Vdat through switching transistor Qs. Each driving transistor Qd outputs an output current (I_{LD}) having a magnitude determined by the corresponding the data voltage Vdat to the OLED LD. Thereby, the OLED LD emits light having an intensity depending on the output current I_{LD}.

Accordingly, four pixels of two rows emit light for two horizontal periods 2H to represent a color of one dot unit arranged in a mosaic, and, at this time, each output current I_{LD} of the four pixels is determined based on the data voltage Vdat considering the efficiency and the life-time of the OLED LD such that the dot represents the color having a desired luminance. In addition, the white pixel PW is included such that the total luminance is improved.

The above-described operations are sequentially repeated to the n-th pixel row to represent images.

In the embodiment of the present invention, the signal controller 600 outputs the image signals DAT_{G} and DAT_{R}, or DAT_{B} and DAT_{W} with respect to two pixel rows to the converters 531G and 531B, or 531R and 531W, at the same time, but the signal controller 600 may separately output the image signals DAT_{G} and DAT_{R}, or DAT_{B} and DAT_{W}, with respect to one pixel row to only corresponding converters 531 G and 531 R, or 531 B and 531 W, in another exemplary embodiment of the present invention. In this case, one of the two converters 531G and 531B, or 531R and 531W, forming a pair normally receives an image signal corresponding to its own color, but the remaining one of the two converters 531G and 531B, or 531R and 531W receives an image signal corresponding a color different from its own color. However, the selectors 535GB and 535RW exactly output only data voltages with respect to the image signals corresponding to their own color by the control of the selection signal SELga. Accordingly, the amount of data that the latch 520 should process for 1 H is reduced by a half to decrease the storing capacity of the latch 520, and thereby the size of the data driver 500 decreases.

Operations of an OLED display including the digital-analog converter 550 shown in FIG. 6 are almost the same as the above-described operations referred to in FIG. 8, except that the converters 555GB and 555RW select the gray voltages from the gray voltage sets VgaG and VgaR, or VgaB and VgaW, from the gray voltage generator 800 instead of the selectors 535GB and 535RW outputting voltages.

Accordingly to the present invention, data voltages are generated based on gray voltages defined based on the light emitting efficiency and the life-time of pixels that are different in accordance with colors such that uniform images are represented. Furthermore, the gray voltage generator or the digital-analog converter is controlled based on a selection signal such that pixels arranged in a mosaic are effectively supplied with data signals.

While the present invention has been described in detail with reference to the preferred embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a first pixel representing a first color;
a second pixel representing a second color;
a first scanning line connected to the first pixel and transmitting a first scanning signal;
a second scanning line connected to the second pixel and transmitting a second scanning signal;
a data line connected to the first pixel and the second pixel and transmitting a data voltage;
a scanning driver applying the scanning signal to the scanning line;
a gray voltage generator generating a first gray voltage set for the first color and a second gray voltage set for the second color; and
a data driver for converting a first image signal for the first pixel into a first gray voltage selected from the first gray voltage set and converting a second image signal for the second pixel into a second gray voltage selected from the second gray voltage set and sequentially applying the selected gray voltages to the data line.

2. The display device of claim 1, wherein the data driver comprises a latch for storing the first image signal and the second image signal together.

3. The display device of claim 2, wherein the data driver substantially simultaneously converts the first image signal and the second image signal.

4. The display device of claim 3, wherein the data driver comprises:
a first converter being supplied with the first gray voltage set and converting the first image signal into the first gray voltage;
a second converter being supplied with the second gray voltage set and converting the second image signal into the second gray voltage; and
a selector for selecting one of the first gray voltage and the second gray voltage.

5. The display device of claim 1, wherein the data driver stores the first image signal and the second image signal at different times from each other.

6. The display device of claim 5, wherein the data driver converts the first image signal and the second image signal at different times from each other.

7. The display device of claim 6, wherein the data driver converts the first image signal into the first gray voltage and into a third gray voltage of gray voltages included in the second gray voltage set, converts the second image signal into the second gray voltage and into a fourth gray voltage of gray voltages included in the first gray voltage set, selects the first gray voltage of the first gray voltage and the third gray voltage to output, and selects the second gray voltage of the second gray voltage and the fourth gray voltage to output.

8. The display device of claim 7, wherein the data driver comprises:
a first converter being supplied with the first gray voltage set, converting the first image signal into the first gray voltage, and converting the second image signal into the fourth gray voltage;
a second converter being supplied with the second gray voltage set, converting the second image signal into the second gray voltage, and converting the first image signal into the third gray voltage;
a selector for selecting one of the first gray voltage and the third gray voltage and selecting one of the second gray voltage and the fourth gray voltage.

9. The display device of claim 6, wherein the gray voltage generator selectively outputs the first gray voltage set and the second gray voltage set.

10. A display device comprising:
a plurality of pixel representing one of a plurality of colors, respectively;
a plurality of scanning lines connected to the pixels and transmitting scanning signals;
a plurality of data lines connected to the pixels and transmitting data voltages;
a scanning driver for applying the scanning signals to the scanning lines;
a gray voltage generator for generating a plurality of gray voltage sets in accordance with the colors; and
a data driver for selecting gray voltages corresponding to image signals from gray voltages included in the gray voltage set, and selecting portions of the selected gray voltages to output to the data lines as the data voltages,
wherein the data lines are connected to the pixels representing colors that are different from each other, respectively.

11. The display device of claim 10, wherein there are four or more colors.

12. The display device of claim 11, wherein the colors are red, green, blue, and white.

13. The display device of claim 10, wherein the data driver comprises:
a first converter for converting an image signal corresponding to a pixel having a first color into the data voltage;
a second converter converting an image signal corresponding to a pixel having a second color into the data voltage; and
a selector for selecting one of the data voltages from the first converter and the second converter.

14. The display device of claim 13, wherein the first converter is supplied with a gray voltage set with respect to the first color, and the second converter is supplied with a gray voltage set with respect to the second color.

15. The display device off claim 10, wherein the data driver alternately converts the image signals with respect to the first color and the second color into the data voltages.

16. The display device of claim 15, wherein the gray voltage generator supplies gray voltage sets with respect to corresponding colors based on the image signals to the converter.

17. A driving method of a display device including a first pixel and a second pixel that are connected to different scanning lines and to the same data line, respectively, the method comprising:
generating a first gray voltage set for the first pixel and a second gray voltage set for the second pixel;
converting a first image signal for the first pixel into a first gray voltage of gray voltages included in the first gray voltage set;
applying the first gray voltage to the data line;
converting a second signal for the second pixel into a second gray voltage of gray voltages included in the second gray voltage set; and
applying the second gray voltage to the data line.

18. The driving method of claim 17, further comprising storing the first image signal and the second image signal together.

19. The driving method of claim 18, wherein the conversion of the first image signal and the conversion of the second image signal are simultaneously performed, and the driving method further comprises: selecting the first gray voltage of the first gray voltage and the second gray voltage before application of the first gray voltage; and selecting the second gray voltage of the first gray voltage and the second gray voltage before application of the second gray voltage.

20. The driving method of claim 17, further comprising:
substantially simultaneously converting the first image signal into the first gray voltage and into a third gray voltage of gray voltages included in the second gray voltage set;
selecting the first gray voltage of the first gray voltage and the third gray voltage;
substantially simultaneously converting the second image signal into the second gray voltage and into a fourth gray voltage of gray voltages included in the first gray voltage set; and
selecting the second gray voltage of the second gray voltage and the fourth gray voltage.

21. The driving method of claim 17, further comprising selectively outputting the first gray voltage set and the second gray voltage set.
